(19) United States
(12) Patent Application Publication
(10) Pub. No.: US 2025/0360716 A1
(43) Pub. Date: Nov. 27, 2025

(54) Removable Wiper Unit for a Printhead Maintenance Unit

(71) Applicant: CANON KABUSHIKI KAISHA, Tokyo (JP)

(72) Inventor: Age BAKKER, Broekhuizenvorst (NL)

(21) Appl. No.: 19/214,748

(22) Filed: May 21, 2025

(30) Foreign Application Priority Data
May 27, 2024 (EP) 24178233.3
Oct. 31, 2024 (EP) 24210051.9

(51) Int. Cl. B41J 2/165

(52) U.S. Cl. CPC B41J 2/16544; B41J 2002/1655

(57) ABSTRACT

A compact and efficiently loadable wiper unit for a maintenance unit of a printer is provided. The wiper unit includes a housing and a plurality of rollers, two rollers of which are configured for holding a roll of wound-up wiper medium, and wherein the remaining rollers define a path for transporting the wiper medium between said two rollers. The path defined by the remaining rollers includes a negative bend extending at least partially outside the housing.

### CROSS-REFERENCE TO RELATED APPLICATIONS

This application claims the benefit of European Patent Application No. 24178233.3 filed on May 27, 2024 and European Patent Application No. 24210051.9 filed on Oct. 31, 2024, all of which are incorporated by reference herein in their entirety.

### BACKGROUND OF THE INVENTION

### Field of the Invention

The disclosure relates to a wiper unit for a printhead maintenance unit of a printer, and to a printer including such a wiper unit.

### Description of Background Art

Printers, specifically sheet printers, may comprise a printhead array, generally referred to as a page wide array. Such an array comprises a plurality of printheads extending over a print medium support surface. A transport mechanism is provided to move print media along the printhead array in continuous motion during which the printheads jet droplets of ink onto the print media to form images. The printheads are stationary during jetting and define a printing range spanning a width of the print media. The droplets are jetted from nozzles provided in one or more nozzle plates in the printhead array. During operation, ink or other contamination may accumulate onto a nozzle plate, which could potentially interfere with the reliable jetting from the nozzles. For example, a nozzle could become (partially) blocked or the droplet size or trajectory is affected by interaction with accumulated ink as the droplet leaves its respective nozzle. It is known to periodically or systemically perform maintenance on a printhead array to at least partially clean the one or more nozzle plates. Cleaning may be performed in various ways, such as wiping, spraying, ultrasonic cleaning, suction, etc. To perform maintenance, it is known to provide a maintenance unit or station next to the print medium support surface. When maintenance is required, the printhead array is moved to a position of the maintenance unit, wherein one or more cleaning actions are performed.

In particular, the nozzle plates may be wiped clean by means of a wiper medium swiping along the printhead array. It is known to provide the wiper medium in roll form, in which a roll is unspooled to provide a constantly clean wiping surface at the nozzle plate. When a roll runs out, it requires replacement.

### SUMMARY OF THE INVENTION

The present disclosure is to improve printhead maintenance operations for a printer, specifically one including a wiper unit.

In accordance with the present disclosure, a wiper unit for a maintenance unit of a printer and a printhead maintenance unit are provided.

The wiper unit includes
a housing;
a plurality of rollers including two rollers configured to hold a roll of wound-up wiper medium, and remaining rollers defining a path for transporting the wiper medium between the two rollers.

The path defined by the remaining rollers includes a negative bend extending at least partially outside the housing.

Two rolls may be present inside the housing on respectively a take-out roller and a take-up roller. The wiper medium is unspooled from the take-out roller to the take-roller via a path determined by the plurality of rollers. In a wiping section, the wiper medium extends outside the housing, preferably on top side of the wiper unit during use. In addition, the wiper unit exposes a portion of the wiper medium in a wetting section, where wetting fluid may be applied to the wiper medium via a wetter included in the printhead maintenance unit. The negative bend turns inwards deeper into the housing towards the center of the bend. This results in a compact embodiment of the wiper unit, which can be swiftly and efficiently loaded in and unloaded from the printhead maintenance unit.

More specific optional features of the disclosure are indicated in the dependent claims.

In an embodiment, the portion of the negative bend extending at least partially outside the housing faces the wiping section of the path where the wiper medium is to contact a printhead array. In the wiping section, the wiper medium forms the highest point of the wiper unit during use. The negative bend curves towards a side of the wiper unit where the wiping section is positioned.

In an embodiment, the plurality of rollers defines a substantially Z-shaped section in the path of the wiper medium, which Z-shape includes the negative bend. During use, the upper leg of the Z-shape extends towards the wiping section. The inclined, middle leg of the Z-shape preferably forms the wetting section.

In an embodiment, the negative bend is defined by three rollers positioned, so that the path of the wiper medium extends towards a wiping section of the path between a first pair of these three rollers, and away from the wiping section between a second pair of these three rollers. In the Z-shape, the middle leg of the Z faces the wiping section, while during use, the bottom leg faces away, preferably towards the take-up roller at the end of the path.

In an embodiment, the housing includes a curved portion, which curves away from a portion of the negative bend in the path of the wiper medium outside of the housing. Near the exposed portion of the negative bend, recesses are provided in side plates of the housing, so that said exposed portion if free from the housing when viewed in a direction parallel to the axes of the rollers. The respective exposed wetting section of the wiper medium is thus easily accessible for the wetter.

In an embodiment, the wiper unit further includes a force pinch mechanism, which force pinch mechanism:
includes at least one roller of the rollers;
is pivotable with respect to the housing; and
is pre-tensioned to provide a substantially constant tension to the wiper medium during use.

The force pinch mechanism ensures a constant and stabile force driving the wiping section against the printhead array. The wiping section is preferably defined by the at least one roller on the force pinch mechanism. The force pinch mechanism can pivot, so the at least one roller moves away or towards the printhead array during use. During use, the wiper medium is tensioned over the at least one roller driving it away from the printhead array. The force pinch mechanism is pre-tensioned opposite to the force exerted by the wiper medium with an, on average, greater force, so that the at least one roller is driven against the printhead array. Preferably, the force pinch mechanism is also pretensioned with a force directing the at least one roller away from the printhead array during use, in case tension in the wiper medium is lost. This latter pre-tension force is smaller than the first mentioned pre-tension forces, so the resulting, total pre-tension is biased towards the printhead array.

In an embodiment, the at least one roller is a toothed roller, the teeth of which are arranged for directly contacting the wiper medium. The toothed roller forms the wiping section, where the wiper medium is brought into contact with the printhead array. The teeth may be continuous like a gear wheel or provided in patterns. The free ends of the teeth are spaced apart from one another, so that the wiper medium is not compressed and allowing it to efficiently take up and hold fluid, including wetting fluid, ink, and other (liquid) contaminants. The at least one roller may be formed of any suitable material, such as rubber, plastic, metal, etc.

In an embodiment, the plurality of rollers includes convex rollers, which define a substantially Z-shaped curve in the path and arranged to drive the wiper medium to a central line of its path. The convex rollers are mounted, so that the wiper medium is constantly aligned towards the middle of its path. This prevents the wiper medium from running out of its path.

In an embodiment, the wiper unit further includes a lamellar roller having a plurality of spaced apart lamina. Downstream of the wiping section, the lamellar roller receives the wiper medium that has been wiped across the printhead array. The lamellar roller directs this wiped/dirty wiper medium towards the take-up roller. The lamina only locally exerts a force on the wiped/dirty wiper medium substantially at a line contact. This prevents or reduces fluid being forced out of the wiper medium.

In an embodiment, the wiper medium includes a locking mechanism releasably securable on a take-up roller of the plurality of rollers, in which the locking mechanism includes a cylindrical body insertable into the take-up roller and locking protrusions each provided on a hinge plate, which hinge plates are arranged to drive the respective locking protrusion into a locking opening of the take-up roller to secure the locking mechanism to the take-up roller. The roll at the take-up roller requires replacing when its capacity has been reached. Replacement is preferably performed quickly and efficiently. The respective roll also includes wiper fluid contaminated with ink or other components, so it should be handled with suitable care. The locking mechanism secures the roll on the take-up roller during use. The locking protrusions form a click-mechanism with the openings in the take-up roller, so that the locking mechanism is secured when the locking protrusions have clicked into the openings. By moving the hinge plates, the locking mechanism can be easily released.

In an embodiment, the locking mechanism includes flange members extending radially beyond the body and securing protrusions, so that a flange is securable between the securing protrusions and the flange members. A flange is provided on one side of the roll on the take-up roller during use. The flange includes a central opening through which the cylindrical body of the locking mechanism is inserted. In another embodiment, the hinge plates extend past the flange members in an axial direction defined by the cylindrical body: the flange members are wider than the central opening and cannot pass through it. The flange is held in place between the flange members and the securing protrusions, which acts as a click mechanism, snapping into place at the flange after passing through the central opening.

In an embodiment, the locking mechanism further includes rotation handles at the flange members for rotating the locking mechanism. The hinge plates extend past the flange members and are positioned, so that these can be pressed towards one another using one hand, thereby releasing the locking mechanism. With the rotation handles, the hinge plates can be positioned in a preferred release position.

In an embodiment, a release mechanism is provided on the housing, which release mechanism includes opposing pressing members positioned for bringing free ends of the hinge plates together for releasing the locking mechanism from the take-up roller. By bringing the release members together, the hinge plates are pressed together thereby releasing the locking mechanism. Since the release mechanism is on the housing, the housing need not be opened or removed for releasing the locking mechanism.

In an embodiment, the release mechanism includes an elastically deformable ring. The ring includes two opposing pressing members. Without a pressing force on the pressing members, the ring returns to its rest state, wherein the pressing members are driven apart and do not interfere with the hinge plates, so the locking mechanism remains securely locked.

In an embodiment, the wiper unit is formed as a cassette releasably mountable on a holding site of a printhead maintenance unit. The cassette can be swiftly placed into or removed from the printhead maintenance unit.

The present disclosure further relates to a printhead maintenance unit using the above described wiper unit in any of its embodiments.

Further scope of applicability of the present disclosure will become apparent from the detailed description given hereinafter. However, it should be understood that the detailed description and specific examples, while indicating embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure.

FIG. 1 is a schematic cross-sectional view of a printer with a printhead maintenance unit;

FIG. 2 is a top-down view of the printer in FIG. 1 with the printhead maintenance unit in its rest position;

FIG. 3 is a top-down view of the printer in FIG. 1 with the printhead maintenance unit moving through its working range in a lateral direction;

FIG. 4 is a detailed, perspective view of the printhead maintenance unit in FIGS. 1-3;

FIG. 5 is a detailed, perspective view of a drive assembly for moving the printhead maintenance unit in FIG. 4;

FIG. 6 is a detailed, side view of a drive assembly with the printhead maintenance unit in a wiper unit loading position defined by a raised rack section;

FIG. 7 is a detailed, side view of a drive assembly with a wetter of the printhead maintenance unit in a lowered, remote wetter position defined by a lower rack section;

FIG. 8 is an enlarged, side view of a first rack segment of the drive assembly in the situation of FIG. 7;

FIG. 9 is an enlarged, side view of a cam mechanism of the drive assembly in the situation of FIG. 7;

FIG. 10 is a detailed, side view of a drive assembly with the wetter in a further lowered, remote wetter position defined by a lower rack section;

FIG. 11 is a detailed, side view of a drive assembly with a wetter in a wetting position defined by a run-out rack section;

FIG. 12 is a further detailed, perspective view of the drive assembly for moving the printhead maintenance;

FIG. 13 is a side view of a wiper unit;

FIG. 14 is a side view of the wiper unit with part of its housing removed;

FIG. 15 is a perspective view of the wiper unit;

FIG. 16 is a perspective view of a force pinch mechanism of the wiper unit;

FIG. 17 is an exploded, perspective side view of the wiper unit;

FIG. 18 is a perspective view of a lamellar roller of the wiper unit;

FIG. 19 is a perspective view of a locking mechanism of the wiper unit;

FIG. 20 is a side view of a locking mechanism of the wiper unit;

FIG. 21 is a perspective view of a flange of the wiper unit;

FIG. 22 is a side view of a locking mechanism engaged in a take-up roller of the wiper unit; and

FIG. 23 is a perspective view of a release mechanism of the wiper unit.

### DETAILED DESCRIPTION OF THE EMBODIMENTS

The present disclosure will now be described with reference to the accompanying drawings, wherein the same reference numerals have been used to identify the same or similar elements throughout the several views.

### Printhead Maintenance Over Print Medium Support Surface

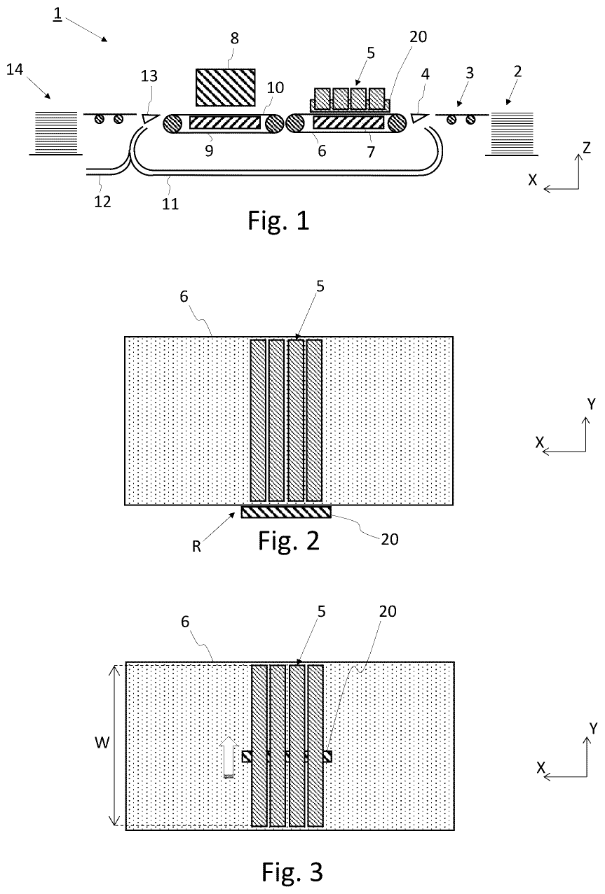

FIG. 1 illustrates a sheet printer 1. Sheets are supplied from an input module 2 onto a transport path 3. The transport path 3 transports the sheets past a printhead array 5, which includes multiple printhead units arranged besides one another in a transport direction X. The transport path 3 below the printhead assembly 5 is formed by an endless belt 6. The endless belt 6 is provided with openings, so that a negative pressure can be applied to sheets on the endless belt 6 via a suction chamber 7. Downstream of the printhead assembly 5, the transport path 3 passes a fixation unit 8. The fixation unit 8 is configured to enhance the liquid ink becoming solid on the sheet. The fixation unit 8 thereto includes one or more emitters for emitting heat or energy in the form of heat, heated air, radiation, etc. towards the sheet. The fixation unit 8 faces a transport belt 10 with a corresponding suction box 9. Downstream of the fixation unit 8, an output switch 13 is provided for selectively directing sheets towards an output module 14 or into a duplex pass 11. Completely printed sheets are passed to the output module 14. Sheets that require duplex printing are passed to the duplex pass 11, where these sheets are flipped by a flipping device 12. The flipped sheets are then inserted at an input switch 4, so that these sheets can return to the printhead assembly 5.

A printhead maintenance unit 20 is provided adjacent the printhead array 5. The printhead maintenance unit 20 is configured for cleaning the printheads in the printhead assembly 5. Each printhead includes a nozzle plate wherein nozzles are formed, from which nozzles marking fluid or ink is jetted. Marking fluid may accumulate and remain on the nozzle plate, which affects the reliable jetting of droplets, especially when the marking fluid accumulates around or at a nozzle. The maintenance unit 20 is configured to at least partially remove accumulated marking fluid from the nozzle plates. Thereto, the maintenance unit 20 may include a wiper assembly, which can be moved along the printhead array to wipe the nozzle plates. It will be appreciated however that other maintenance devices, such as sprayers, brushes, ultrasonic cleaners, etc. may be applied instead of wiping.

FIG. 2 illustrates the maintenance unit 20 in its rest position R. The rest position is besides the printhead assembly 5 in a lateral direction Y. The lateral direction Y is perpendicular to the transport direction X and lies in the plane of the transport path 3. The transport path 3 is defined by the endless belt 6, which also forms the print medium support surface. The printhead array 5 is a so-called page wide printhead array which defines a working range W. The working range W covers preferably the majority of the width of the endless belt 6 in the lateral direction Y. In its rest position R, the maintenance unit 20 is adjacent to the printhead assembly 5, preferably within 10-20 centimeters, but does not interfere with the jetting operations of the printhead array 5.

FIG. 3 illustrates the maintenance unit 20 moving along the printhead assembly 5 in the lateral direction Y. The maintenance 20 moves out of the rest position R and into the working range W. The maintenance unit 20 is configured to move along the full working range W, so as to wipe every nozzle in the printhead array 5. This results in a compact structure, as the dimension of the maintenance unit 20 in the lateral direction Y is generally less than that of the printhead assembly 5. During wiping, the printhead assembly 5 is stationary and has the same lateral position as during printing. The movement range of the maintenance unit 20 overlaps and/or is similar to the printing range wherein the printhead assembly 5 is arranged to print.

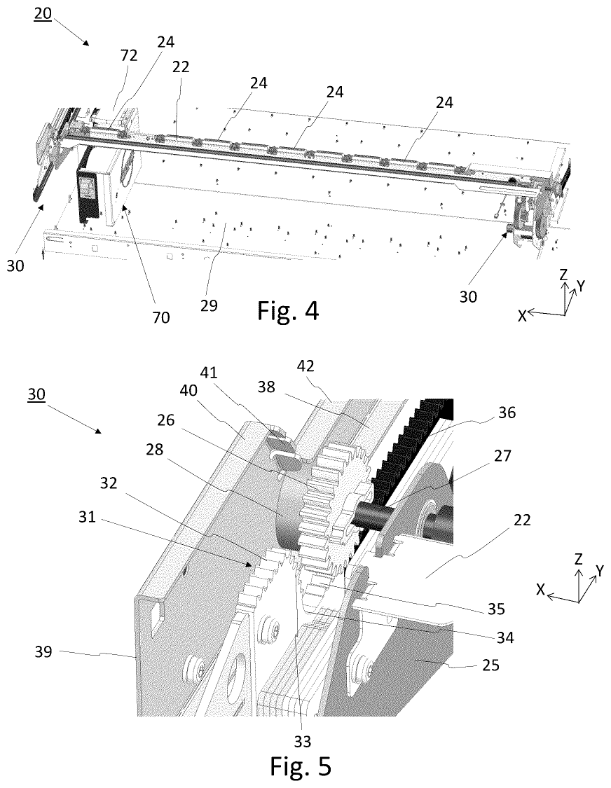

FIG. 4 is a more detailed view of the maintenance unit 20. The maintenance unit 20 includes a wetter 22 configured to hold a plurality of wiper units 70. In FIG. 4, only a single wiper unit 70 is shown, but it will be appreciated that a similar wiper unit 70 may be provided at any of the respective wiper unit holding sites. Each wiper unit site is provided with a respective wetting device in the form of a wetting roller 24. The wetter 22 is provide with a wetting fluid channel extending in the transport direction X. Wetting fluid flows through the wetting fluid channel, so that the wetting fluid channel is provided to each respective wetting roller 24. A wetting fluid source (not shown), for example a fluid reservoir with a pump, is connected to the wetting fluid channel.

The left most wiper unit site is provided with a respective wiper unit 70. The wiper unit 70 includes a wiper medium 72, which uses a tissue, sheet, paper, etc. for cleaning the nozzle plate(s). In FIG. 4, the wiper medium 72 is provided in roll form inside the wiper unit 70, so that the wiper medium can be unspooled during wiping to prevent smearing marking fluid over a nozzle plate. The wiper unit 70 can be secured to the wetter 22, so that the wiper unit moves with the wetter 22. A drive assembly 30 is provided for moving the wetter 22 and the wiper unit 70 in the lateral direction Y.

### Drive Assembly

The drive assembly 30 is illustrated in detail in FIG. 5. The drive assembly 30 includes a first drive wheel 26 in the form of a gear wheel coupled to a guide roller 28. The guide roller 28 has a smooth outer surface, whereas the first drive wheel 26 is a gear or cog with teeth. The first drive wheel 26 and the guide roller 28 are mounted onto a support axis 27. The support axis 27 is rotatably provided in a support structure 25. The support structure 25 in FIG. 5 is formed as a plate. The wetter 22 is mounted onto the support structure 25. The wetter 22 is rigidly connected to the support structure 25 by means of screws.

The first drive wheel 26 engages a gear rack 31. The gear rack 31 is rigidly connected to a printer frame 39. The printer frame 39 is stationary during operation. By rotating the first drive wheel 26, the wetter 22 and the wiper units 70 can be moved in the lateral direction Y. The gear rack 31 includes multiple sections: at the end nearest the rest position R, a raised rack section 32 is provided. The raised rack section 32 is above a run-out rack section 36. The run-out rack section 36 is parallel to the lateral direction Y and extends over the print medium support surface of the endless belt 6. The raised rack section 32 is formed of a first gear rack segment, which is separate from a second gear rack segment, in which the second gear rack segment includes the run-out rack section 36. The second gear rack segment is preferably a linear or straight gear rack. The first gear rack segment further includes a lower rack section 35, which is parallel to and at the level of the run-out rack section 36. An inclined rack section 33 is present between the raised and lower rack sections 32, 35 to partially overcome the height difference between these two sections 32, 35. Between the inclined rack section 33 and the lower rack section 35, an inclined, a toothless section 34 is positioned. The toothless section 34 extends downward in the lateral direction Y to the level of the lower rack section 35. The toothless section 34 is substantially, i.e. free of any teeth that may engage the first drive wheel 26. The toothless section 34 allows the first drive wheel 26 to transition from the raised rack section 32 to the lower rack section 35 in a smooth manner, while allowing for a space-efficient construction. When moving in the lateral direction Y, the first drive wheel 26 descends the inclined rack section 33, passing through the toothless section 34, into engagement with the lower rack section 35.

The movement of the first drive wheel 26 is defined by the gear rack 31. In addition, the movement is guided by the guide roller 28. The guide roller 28, provided on the same support axis 27 as the first drive wheel 26, is adjacent to the first drive wheel in the transport direction X. The trajectory of the guide roller 28 is restricted by the guides formed by restrictors 38, 40-42 provided on or in the printer frame 39. The printer frame 39 encloses the guide roller 28 in the transport direction X. This prevents the first drive wheel 26 from coming of the gear rack 31 in the transport direction X. In addition, upwards movement of the guide roller 28 is restricted by the upward movement restrictors 40-42. The upward movement restrictors 40-42 extend over the trajectory of the guide roller 28 and ensure that the first drive wheel 26 is unable to move upwards out of engagement with the gear rack 31. On the level rack sections 32, 36, the upward movement restrictors 40, 42 extend parallel to the lateral direction Y. Over the inclined rack section 33, the respective upward movement restrictor 41 is also inclined. The inclined upward movement restrictor 41 is positioned, so that when descending or ascending the inclined rack section 33, the first drive wheel 26 remains in engagement with the gear rack 31. In FIG. 5, the upward movement restrictors 40-42 are formed as a bent portion of the plate that forms the printer frame 39.

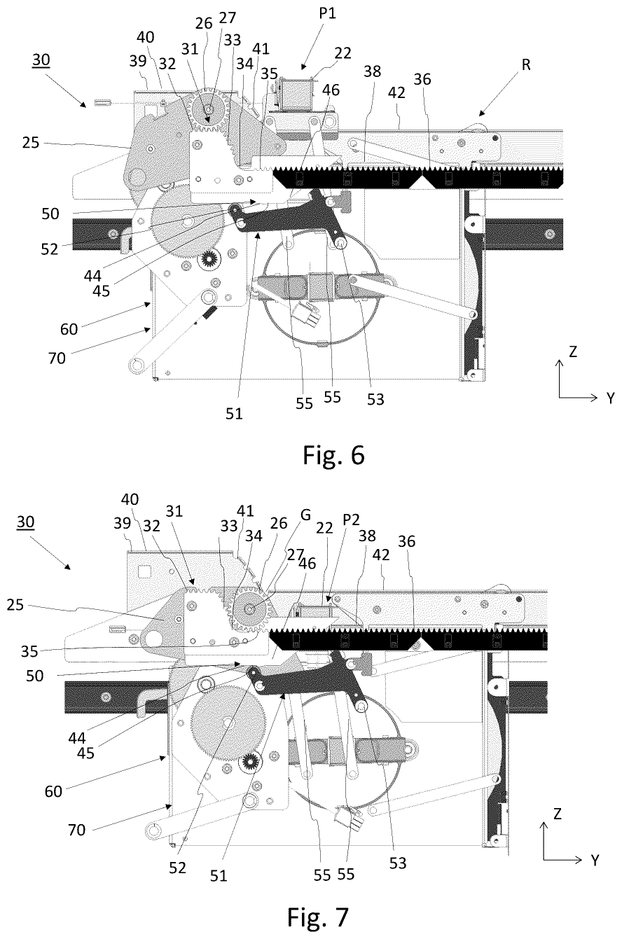

FIG. 6 illustrates the maintenance unit 20 in a loading position, wherein the wiper units 70 can be removed and/or inserted into the maintenance unit 20. In the loading position, the first drive wheel 26 is positioned at the raised rack section 32. As a result of this raised position, the support structure 25 has also been pivoted into a raised position. In addition, the wetter 22 connected to the support structure 25 has also been moved into a raised position. This positions the wetter 22 and its wetting rollers 24 away from the wiper unit 70. This allows the wiper unit 70 to be slid out of the maintenance unit 70 by moving it opposite to the lateral direction Y. A rod mechanism 55 is provided to support the wetter 22. The rod mechanism 55 is configured to maintain the wetter 22 substantially horizontal to prevent leaking of the wetting fluid out of the wetting fluid channel. The rod mechanism 55 moves downward with the wetter 22 between FIGS. 6 and 7.

The wiper unit 70 is loaded by inserting it into a wiper unit holder 60. A wiper unit holder 60 is provided for each respective printhead unit. The wiper unit holder 60 includes a wiper unit support 29, whereupon the wiper unit 70 is supported in the maintenance unit 20. The wiper unit holder 60 includes a wiper unit support frame, which moves with the wetter 22. As shown in FIG. 12, the wiper unit support frame may be provided with a roller to allow quick and easy insertion and retraction of a wiper unit 70 into the wiper holder 60.

A cam mechanism 51 is provided for moving the wetting device 24 into contact with the wetting medium 72, when moving in the lateral direction Y. A follower wheel 52 is provided with a cam arm. The cam arm is pivotable around a cam axis 53. The follower wheel 52, the cam arm, and the cam axis 53 move with the first drive roller 26 as it moves in the lateral direction Y. A cam surface 50 is provided stationary with respect to the gear rack 31. The cam surface 50 has a first surface section including a protrusion 52 and a second surface section 46, which is inclined with respect to the vertical direction Z. The cam mechanism 51 will be explained in detail below with respect to FIGS. 7-10.

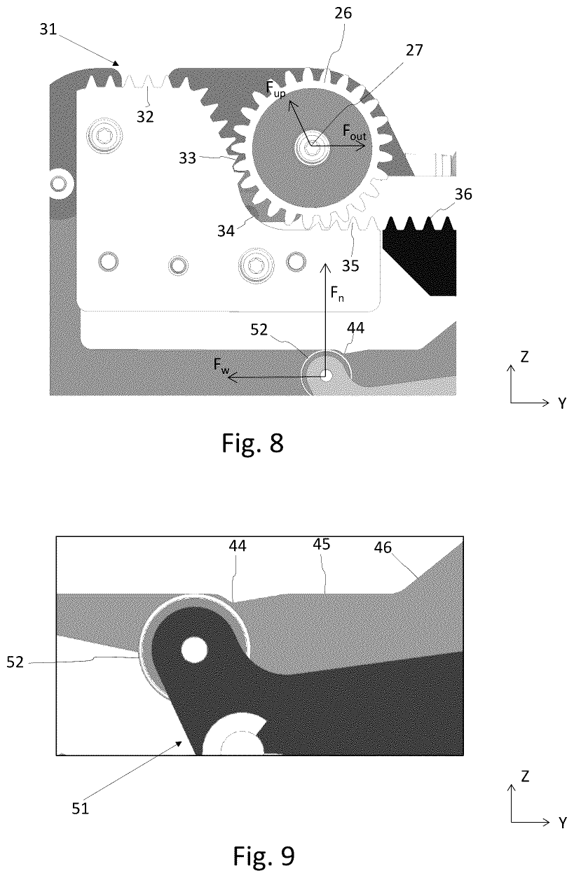

FIG. 7 illustrates the maintenance unit 20 with the first drive wheel 26 in a first lower position. With respect to FIG. 6, the first drive wheel 26 has been driven to move in the lateral direction Y, so that the first drive wheel has descended the inclined rack section 33. Initially, the first drive wheel 26 moved over the raised rack section 32, therein being confined by the upward movement restrictor 40. The upward movement restrictor 40 prevented the guide roller 28 from moving upwards, preventing the first drive wheel 26 from losing contact with the gear rack 31. The first drive wheel 26 then arrived at the inclined rack section 33, where it began descending the gear rack 31. To allow the first drive wheel 26 to pass through the lower turn, a toothless section 34 is provided at said turn, as indicated in FIG. 8. The toothless section 34 is sufficiently small, so that the first drive wheel 26 can maintain simultaneous contact with the teeth of the inclined rack section 33 and the lower rack section 35. During this descending movement, the inclined restrictors 41 prevent the first drive wheel 26 from coming off the gear rack 31. FIG. 7 illustrates a gap G in the upward movement restrictor 40 facing the toothless section 34. The gap G is between the inclined restrictor 41 and the run-out restrictor 42 extending over the run-out rack section 36. The gap G provides sufficient degrees of freedom, so the first drive wheel 26 is able to pass through the toothless section 34. In case a restrictor would have been provided at the position of the gap G, the first drive wheel 26 would become stuck there, caught between the teeth in the gear rack 31 and the upward movement restrictor 40.

As the first drive wheel 26 descends, the support axis 27 moves downward, pivoting the support structure 25 downward. This forces the wetter 22 downward, so that the wetter 22 is at its operative level, where it will be during wiping operations. The rod mechanism 55 moves accordingly to bring the wetter 22 down, while substantially keeping the wetter horizontal to prevent spilling of wetting fluid.

During this movement, the follower wheel 52 of the cam mechanism 51 follows a substantially level surface section 45 of the cam surface 50, so that the cam mechanism 51 is prevented from actuating, as shown in FIG. 9. The substantially level surface section 45 is flat or horizontal with the exception of a single protrusion 44. The follower wheel 52 does run up to the protrusion 44 included in this section 45, which prevents the first drive wheel 26 from coming off the gear rack 31, when the first drive wheel 26 is at the gap G in the upward movement restrictor 40. At the gap G, the first drive wheel 26 is not prevented by the upward movement restrictor 40 from coming free from the gear rack 31. Instead, the cam mechanism 51 prevents the first drive wheel 26 from coming free from the gear rack 31. When at the protrusion 44, the cam mechanism 51 exerts a counterforce F_{w} on the first drive wheel 26, which urges the first drive wheel 26 towards the toothless section 34. The protrusion 44 is in the form of a slight bump. The bump is sufficiently large to allow the cam mechanism 51 to act as a brake, which prevents uncontrolled rolling out of the first drive wheel 26. When the first drive wheel 26 rolls upwards against the lateral direction Y at the inclined gear section 33, it is driven by an upwards force Fᵤₚ. Via the interaction with the gear rack 31, the first drive wheel 26 further experiences a reactionary outward force Fₒᵤₜ, which could drive the first drive wheel 26 out of contact with the teeth of the gear rack 31 when at the gap G. The protrusion 44 is dimensioned, so it results in a normal force Fₙ, wherein Fₙ is the vertical force required to overcome the protrusion 44. The shape of the protrusion 44 further provides an accompanying counter force F_{w} opposite to the lateral direction Y. The counter force F_{w} is opposite to the outward force Fₒᵤₜ, but the protrusion 44 is dimensioned, so that the counter force F_{w} is larger than the outward force Fₒᵤₜ. The follower wheel 52 is unable to pass the protrusion 44 without an additional driving force from a motor. The outward Fₒᵤₜ will never be sufficiently great by itself, to overcome the counterforce F_{w}. Since the first drive wheel 26 is connected to the follower wheel 52, the first drive wheel 26 is thereby prevented from coming out of contact with the gear rack 31 at the gap G. It will be appreciated that the above-described mechanism also prevents the first drive wheel 26 from coming off the gear rack 31 when the first drive wheel 26 is driven into descent on the respective section. When descending, the weight of the construction provides an additional force forcing the first drive wheel 26 onto the gear rack 31.

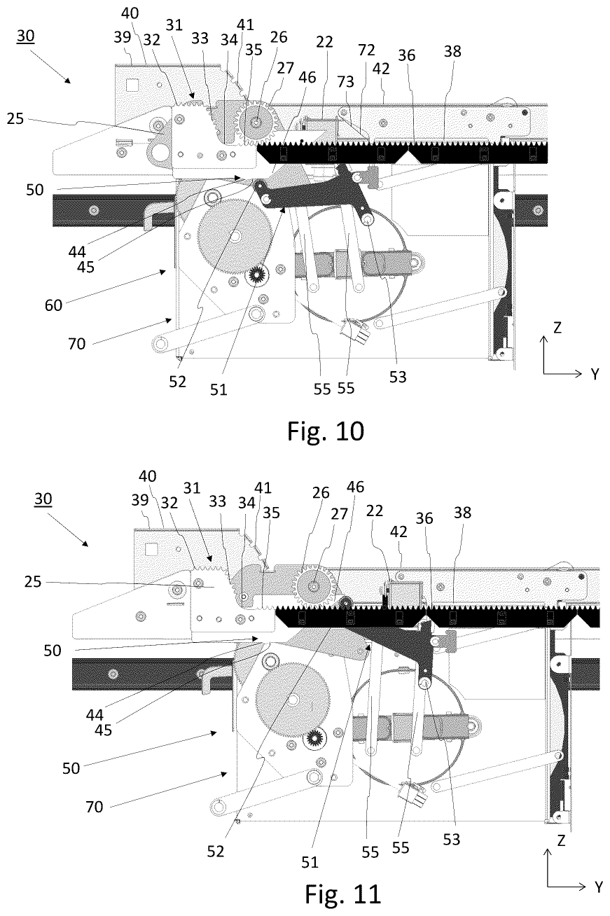

FIG. 10 illustrates the first drive wheel 26 transitioning from the first gear rack segment to the horizontal second gear rack segment formed by run-out rack section 36. The first drive wheel 26 is at the level of shown in FIG. 7, so the wetter 22 is at the same level as in FIG. 7. The follower wheel 52 of the cam mechanism 51 has passed the protrusion 44, but still remains 1 on the level surface section 45. Movement is controlled by driving the first drive wheel 26. It will be appreciated that in any of the FIGS. 4 to 10 the maintenance unit 20 may still be considered to be in its rest position. The maintenance unit 20 in these Figures is still in a non-wiping mode.

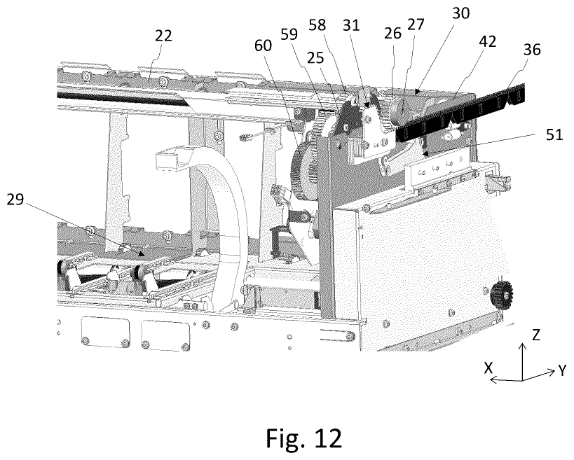

FIG. 11 shows the first drive wheel 26 progressing further onto the run-out rack section 36. In FIG. 11, the maintenance unit 20 enter its wiping mode. Therein the wetter 22 is moved with respect to the wiper unit 70, so that the wetting rollers 24 are in contact with the wetting medium 72. Thereby, the wetting medium 72 is actively wetted by wetting fluid supplied via the wetting fluid channel in the wetter 22. The relative movement of the wetter 22 and the wiper unit 70 is controlled by the cam mechanism 51. In FIG. 11, the follower wheel 52 engages the inclined cam surface 46, thereby actuating the cam arm. The movement of the cam arm forces the wetter 22 and its corresponding wetting section (WE in FIG. 14) of the wiper medium 72 together. The movement is defined by a rod mechanism 55, which is configured to maintain the wetter 22 substantially horizontal during the movement. As shown in FIG. 10, the wiper unit 70 defines a wetting portion 73, wherein the wetting medium 72 is exposed. At the wetting portion 73, the wetter 22 engages the wetting medium 72 and transfers wetting fluid into the wetting medium 72.

In FIG. 11 the maintenance unit 20 is in its wiping mode and moves in the working range W. The wetter 22 actively wets the wiper medium 72. A wiping section (WI in FIG. 14) of the wiper medium 72 is wiped along the nozzle plates of the printhead assembly 5. The wiper medium 72 is unspooled during the lateral movement, so that each section of a nozzle plate is wiped with a clean portion of wiper medium 72. The wiper medium 72 containing ink is spooled away from the printheads. It will be appreciated that in the contact area the velocity of the wiper medium 72 with respect to the printer frame 39 is preferably equal to or (slightly) greater than that of the first drive wheel, the wiper unit 70 and/or the wetter 22.

FIG. 12 illustrates the driving wheels of the drive assembly 30. It is noted that all the movements in FIGS. 4 to 11 are controlled by means of a single motor, which in this example drives the motor wheel 60. The motor wheel 60 drives the first drive wheel via a plurality of transmission wheels 58, 59. In FIG. 12, all wheels 26, 58-60 are interconnected gear wheels, specifically double gear wheels, wherein the number of teeth of the receiving wheel is different from that of the connected wheel. This allows the appropriate speeds to be achieved.

### Wiper Unit

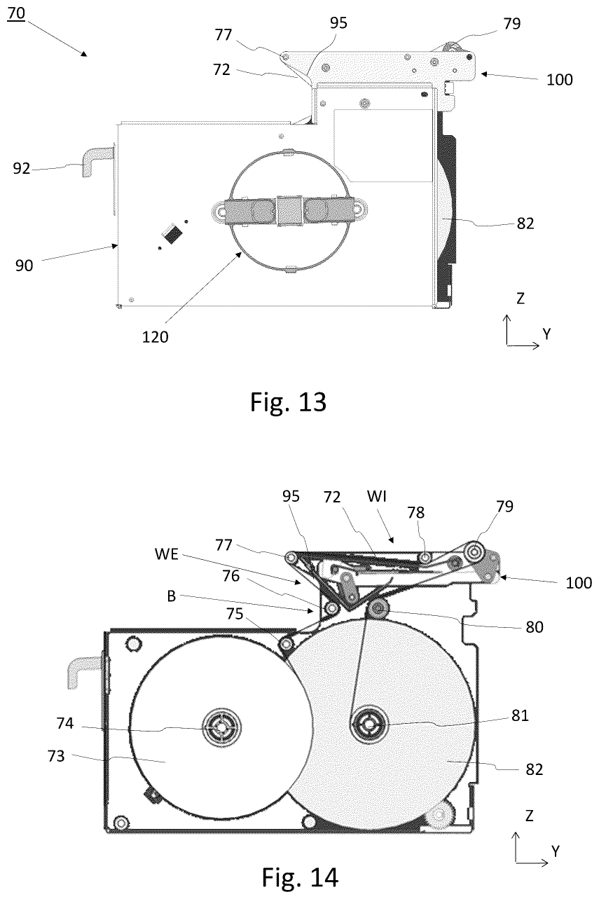

A single wiper unit 70 is shown in FIG. 13. The wiper unit 70 is formed as a removable cassette capable of holding a roll of wiper medium 72. The wiper unit 70 allows the wiper medium 72 to be spooled, so that it wipes across the nozzle plate(s). The wiper medium 72 is rewound into a second roll 82. The rolls 82 are positioned inside a housing 90, which forms an outer body of the wiper unit 70. The housing 90 is provided with a grip 92 that allows for easy manual removal of the wiper unit 70 from its respective holding site by pulling on the grip 92 opposite to the lateral direction Y when the maintenance unit 20 is in the (un)loading position in FIG. 6.

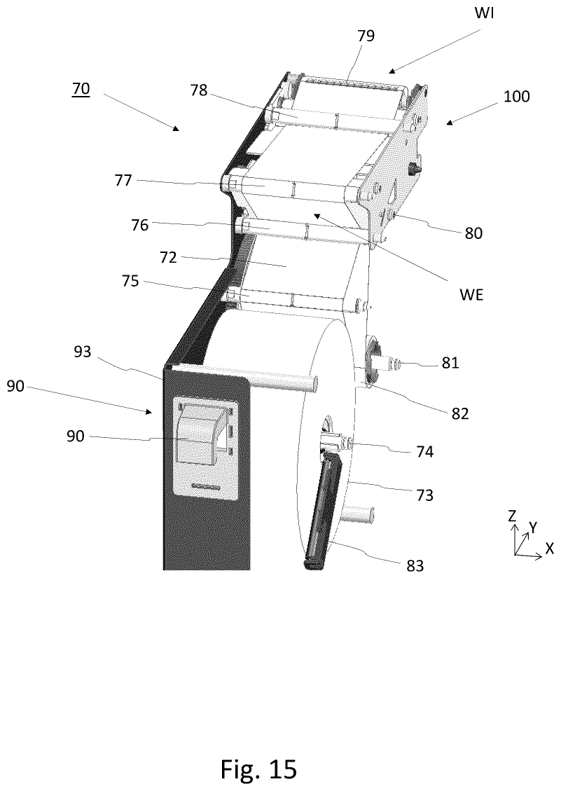

The path of the wiper medium 72 through the wiper unit 70 is illustrated in FIGS. 14 and 15. FIG. 14 shows the wiper unit 70 without one of the side panels forming the housing 90. The wiper medium 72 is provided as a first roll 73 on a first roller 74. A limiter 83 may be provided to maintain the shape and position of the first roll 73. From the first roll 73, the wiper medium 72 runs across a plurality of convex roller 75-78, so that a portion of the wiper medium 72 extends outside the housing 92. A diameter of the convex rollers 75-78 is greater in the middle of each respective roller 75-78 in the transport direction as compared to its ends. The diameter gradually decreases towards either end. This convex shape in combination with the bend(s) in the path of the wiper medium 72 provided by the convex rollers 75-78 continuously steers the wiper medium 72 to the middle of these rollers 75-78. Thus, the position of the wiper medium 72 is restricted without requiring an active or automated control mechanism.

The convex rollers 75-78 further define a wetting section WE, where the wetter 22 can apply the wetting fluid to the wiper medium 72. In the wetting section WE, the wiper medium 72 extends outside the housing 90. Curved recesses 95 have been provided in side plates of the housing 90 to allow the wetter 22 to engage the wiper medium 72 in the wetting section WE. The convex rollers 75-78 define a negative turn in the path of the wiper medium 72. Inside this negative turn, a portion of the wiper medium 72 is exposed, so that it is accessible to the wetter 22. At the negative turn, the wiper medium 72 is thus wetted, when the printhead maintenance unit 20 is in its wetting position in FIG. 11. The wiper medium 72 is wetted between the central convex rollers 76, 77. Downstream of the first central convex roller 76, the wiper medium 72 is provided with wetting fluid during a wetting operation.

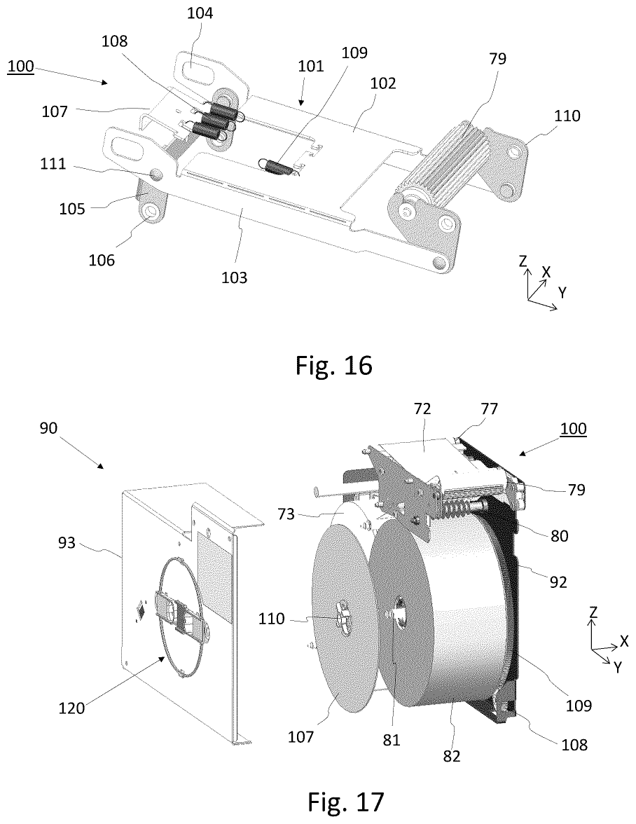

The downstream convex rollers 77-78 interact with a force pinch mechanism 100 via the wiper medium 72. The force pinch mechanism 100 provides a substantially constant tension in the wiper medium 72 during operation. The force pinch mechanism 100 is shown in detail in FIG. 16. The force pinch mechanism 100 includes a frame 102, which is pivotably or rotatably mounted to the housing 90. The frame 102 is pivotable around an axis extending in the transport direction X and provided through the axis openings 106. The axis openings 106 are formed in pivot arms 105, which define the movement of the frame 102. The pivot arms 105 are rigidly fixed to the frame 102 by securing means 111. The frame 102 is further connected to the housing 90 by means of spring elements 108, 109. The spring elements 108, 109 are pre-tensioned in both directions of the movement of the frame 102 around the axis in the axis openings 106. In FIG. 16, more spring elements 108 are provided on one side as compared to the single spring element 109 on the opposite side. During operation, the wiper medium 72 is generally under tension and this tension acts opposite the spring elements 108. In case tension is temporarily reduced, an opposing spring element 109 is provided. Effectively, the spring elements combined urge the force pinch mechanism 100 towards the printhead array 5. In addition, movement of the frame 102 may be limited to a predetermined range, for example by means of limiting openings 104, which engage a stop rigidly mounted to the housing 90 to define end positions for the movement of the frame 102. Such a stop may be formed by e.g. a certain convex roller 77.

In FIG. 16, the force pinch mechanism 100 further includes a toothed roller 79, which defines a wiping section WI. In the wiping section WI, the wiper medium 72 wipes across the printhead array during a cleaning operation. The toothed roller 79 includes teeth-like protrusions extending in the transport direction X during use, resembling a fine toothed gear. The toothed roller 79 is the first roller that comes into contact with the wiper medium 72 that has wiped ink or contamination from the nozzle plate(s). The toothed roller 79 prevents or reduces the chance of fluid being squeezed from the wiper medium 72 by only locally pressing on the wiper medium 72. The toothed roller 79 is rigidly connected to the frame 102 by the panels 110.

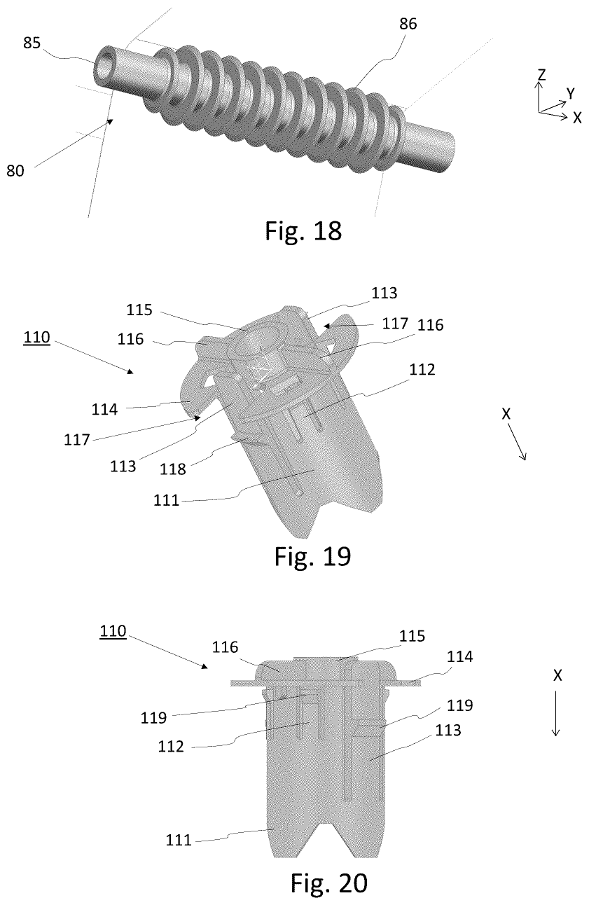

As shown in FIG. 17, from the toothed roller 79, the wiper medium 72 extends over a lamellar roller 80. The lamellar roller 80 is shown in FIG. 18. The lamellar roller 80 has an axis body 85 which extends in the transport direction X during use. The axis body 85 is provided with a plurality of lamina 86. Each of the lamina 86 is shaped as a circular disc. The discs are spaced apart along the transport direction X. Towards the ends the (outer) lamina may decrease in diameter. The lamina 86 prevents fluid from being forced out of the wiper medium 72. Pressure to the wiper medium 72 is applied only locally at the lamina 86 and not in the regions in between. This prevents contaminated wiper fluid from being forced out of the wiper medium 72.

FIG. 17 illustrates the mounting of the take-up roller 81 for the second roll 82. The take-up roller 81 extends through the second roll 82. On the right side, the take-up roller 81 is provided with a gear wheel 109 for rotating the roll 82. The gear wheel 109 is driven by means of a motor wheel 108. On the left side in the transport direction X, the second roll 82 is confined by a flange 107. It will be appreciated that a similar flange may be provided between the second roll 82 and the gear wheel 109. The flange 107 is secured to the take-up roller 81 by means of a locking mechanism 110. The locking mechanism 110 is positioned to interact with a release mechanism 120, which is provided in a housing part 93. The housing parts 92, 93 form the housing 90 enclosing the rolls 73, 82.

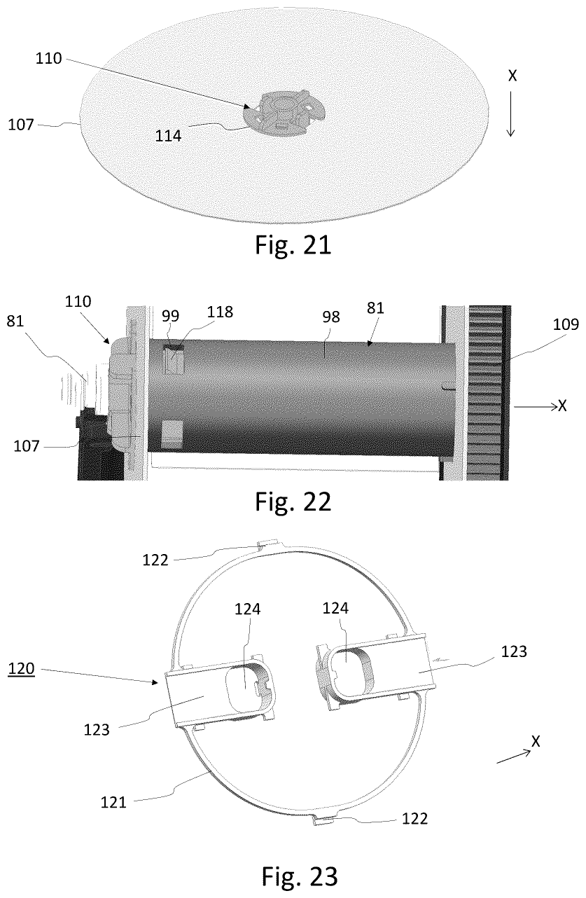

The locking mechanism 110 is illustrated in FIGS. 19 to 21. The locking mechanism 110 includes a cylindrical body 111. The body 111 is provided with flange members 114 near one of its ends. The flange members 114 extend perpendicular to the main axis of the body 111. The locking mechanism 110 includes a click mechanism formed by a locking protrusion 118 mounted on a hinge plate 113. The hinge plate 113 allows the locking protrusion 118 to move towards and away from the main axis of the body 111. The hinge plate 113 is formed in the wall of the body 111 by recesses provided therein. In a neutral position of the hinge plate 113, the locking protrusion 118 extends radially beyond the body 111. A similar locking protrusion 118 with a hinge plate 113 is provided on an opposite side of the body 111. Between the flange members 114, recesses 117 are provided through which the free ends of the hinge plates 113 extend beyond the flange members 114 opposite to the transport direction X. In between these free ends, an opening 115 is provided in the form a ring to receive an end of the take-up roller 81. At the level of this ring, rotating handles 116 are provided on the flange members 114. The rotating handles 116 are formed, so that these can be easily engaged for rotating the locking mechanism 110. As shown in FIG. 21, the flange 107 includes a central opening through which the cylindrical body 111 fits. The flange members 114 are wider and cannot pass through the central opening. On the opposite side of the flange 107, securing protrusions 119 extend beyond the radius of the body 111, so that the flange 107 is secured between the securing protrusions 119 and the flange members 114. The securing protrusions 119 are provided on their respective hinge plates 112, which are configured to pivot inward as the cylindrical body 111 moves through the central opening of the flange 107. The securing and locking protrusions 118, 119 are provided with an inclined portion to aid forcing the hinge plates 112, 113 inward. On a side facing the flange members 114, the securing and locking protrusions 118, 119 include a flat abutment surface, which acts as a stop.

FIG. 22 illustrates the locking mechanism 110 engaged in the take-up roller 81. The take-roller 81 has a hollow cylindrical roller body 98, wherein openings 99 are formed at corresponding positions for the locking protrusions 118 of the locking mechanism 110. The cylindrical body 111 of the locking mechanism 110 is inserted through the flange 107 into the roller body 98. The cylindrical body 111 is rotated, so that the locking protrusions 118 are at the positions of the openings 99. The hinge plate 113 then re-assumes its rest position and drives the locking protrusions 119 through the openings 99, thereby securing the locking mechanism to the take-up roller 81.

The locking mechanism 110 can be released from the take-up roller 81 by means of the release mechanism 120. The release mechanism 120 is secured to the housing part 93 by means of the clamps 112. The release mechanism 120 includes an elastically deformable ring 121 with opposing pressing members 123. Each pressing member 123 is provided with a finger grip 124 for easy engagement by an operator. The pressing members 123 in their rest positions are positioned facing each other as well as the free ends of the hinge plates 113. The rotating handles 116 can be used to rotate the locking mechanism 110 in the correct orientation with respect to the release mechanism 120. When moving the pressing members towards one another, the hinge plates 113 are forced inward. Thereby, the locking protrusion 118 is moved out of the opening 99 in the take-up roller 81. That allows the locking mechanism 110 to be slid from the take-up roller 81. This allows the second roll 82 on the take-up roller 81 to be removed and a fresh roll can be loaded.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

The present disclosure being thus described, it will be obvious that the same may be varied in many ways. Such variations are not to be regarded as a departure from the spirit and scope of the present disclosure, and all such modifications as would be obvious to one skilled in the art are intended to be included within the scope of the following claims.

1. A wiper unit for a maintenance unit of a printer, the wiper unit comprising:
a housing; and
a plurality of rollers including
two rollers configured to hold a roll of wound-up wiper medium, and
remaining rollers defining a path for transporting the wiper medium between the two rollers,
wherein the path defined by the remaining rollers includes a negative bend extending at least partially outside the housing.

2. The wiper unit according to claim 1, wherein the remaining rollers include three rollers that define the negative bend and are positioned so that the path of the wiper medium extends (a) towards a wiping section of the path between a first pair of the three rollers, and (b) away from the wiping section between a second pair of the three rollers.

3. The wiper unit according to claim 1, wherein the housing comprises a curved portion that curves away from a portion of the negative bend in the path of the wiper medium outside of the housing.

4. The wiper unit according to claim 1, further comprising a force pinch mechanism including at least one roller of the plurality of rollers, wherein the force pinch mechanism is pivotable with respect to the housing and is pre-tensioned to provide a substantially constant tension to the wiper medium during use.

5. The wiper unit according to claim 4, wherein the at least one roller is a toothed roller having teeth arranged to directly contact the wiper medium.

6. The wiper unit according to claim 1, wherein the plurality of rollers comprises convex rollers positioned so as to define a substantially Z-shaped curve in the path and arranged to drive the wiper medium to a central line of the path.

7. The wiper unit according to claim 1, further comprising a lamellar roller including a plurality of spaced apart lamina.

8. The wiper unit according to claim 1, further comprising a locking mechanism configured to secure on a take-up roller of the plurality of rollers, the locking mechanism comprising:
a cylindrical body configured to be inserted into the take-up roller; and
locking protrusions each provided on a hinge plate, wherein the hinge plates are arranged to drive the respective locking protrusion into a locking opening of the take-up roller to secure the locking mechanism to the take-up roller.

9. The wiper unit according to claim 8, wherein the locking mechanism further comprises flange members extending beyond the body and securing protrusions, so that a flange is securable between the securing protrusions and the flange members.

10. The wiper unit according to claim 9, wherein the hinge plates extend past the flange members in an axial direction defined by the cylindrical body.

11. The wiper unit according to claim 8, wherein the locking mechanism further comprises rotation handles at the flange members for rotating the locking mechanism.

12. The wiper unit according to claim 9, further comprising a release mechanism is provided on the housing, the release mechanism including opposing pressing members positioned to bring free ends of the hinge plates together so as to release the locking mechanism from the take-up roller.

13. The wiper unit according to claim 12, wherein the release mechanism comprises an elastically deformable ring.

14. The wiper unit according to claim 1, wherein the wiper unit is formed as a cassette releasably mountable on a holding site of a printhead maintenance unit.

15. A printhead maintenance unit comprising at least one holding site configured to mount a wiper unit according to claim 1.
